(19) United States
(12) Patent Application Publication
(10) Pub. No.: US 2008/0302009 A1
(43) Pub. Date: Dec. 11, 2008

(54) Mural Support For Any Type of Natural Plants

(75) Inventors: Alain Frecon, Marseille (FR); Thibaut De Breyne, Marseille (FR); Philippe Tisserand, Marseille (FR)

Correspondence Address: CANTOR COLBURN, LLP, 20 Church Street, 22nd Floor, Hartford, CT, 06103, US

(73) Assignee: JARDIN IMPREVU, Marseille (FR)

(21) Appl. No.: 12/095,074

(22) PCT Filed: Nov. 24, 2006
(86) PCT No.: PCT/FR06/02582

§ 371 Date: May 27, 2008

(30) Foreign Application Priority Data
Nov. 25, 2005 (FR) 0511935

(51) Int. Cl. A01G 9/02

(52) U.S. Cl. 47/83; 47/65.5

(57) ABSTRACT

The invention concerns a mural support for any type of natural plants, consisting of a mural support (1) with vertical front surface comprising one or more receptacles (2) provided each with an opening located in the same plane as said front surface, the receptacles being equipped at the periphery of their opening with an inner rim adapted to retain, when the support is fixed to a wall, one or more plants (4) capable of being conditioned in a soil clod (3). The invention concerns the industrial and commercial field of manufacture and distribution of articles or decorating residential as well as professional premises.

### FIELD OF THE INVENTION

The present invention relates to a wall support for all types of natural plants.

It relates to the industrial and commercial field of the manufacture and distribution of articles for ornamenting walls and in particular indoor walls of residential as well as professional premises.

### BACKGROUND

Until today, the decoration of the walls is generally obtained by using very thin flat objects, such as pictures, drawings, photographs, posters, etc.

The plants used for this purpose are generally placed in pots placed on shelves, thereby considerably limiting the potential applications, due to the size, cost and the installation works required.

Wall supports for plants are known, such as, for example, the one described in patent No. FR 1 498 243, which describes a plant cultivation wall, tilted to the horizontal and capable of rotating about a vertical axis in order to control the insulation to improve the cultivation yield, the wall being made from masonry and covered with a prefabricated outer panel in the form of a rack made from plastic, asbestos-cement or a similar material.

Mention can also be made of patent No. FR 2 860 022, which describes a modular structure, accommodating ornamental plants to form a plant screen intended to mask a wall of a building or other wall, the said structure consisting of a plurality of joined adjacent modules. Each of these modules is formed of a frontal frame behind which another rigid elementary frame is fixed, the frontal frame comprising grooves receiving a retaining member and a sealed separating partition.

Patent No. FR 2 857 396 describes a façade lining incorporating a planting device and consisting of modules designed to be joined into vertically and horizontally consecutive elements, each module being formed of a box having an outside perforated with one or more openings and fixed to a back plate arranged to permit a vertical and horizontal overlap.

The devices described in these patents are all designed to be mounted outdoors and to constitute walls, or to form wall linings by joining modules.

### SUMMARY

On the contrary to the above, the device according to an exemplary embodiment of Applicant's disclosure is designed for a local wall decoration and primarily intended to be used indoors, in residential as well as professional premises, an apartment, an office or a store, without excessive expenditure, and without requiring special works. It is an ornamental element suitable for playing the same role as a picture, which is far removed from the functions of the devices described in the above patents. It serves in fact to place natural plants on a wall as easily as one hangs a picture.

Thanks to its very reasonable price and its reduced thickness, it can be used to decorate the wall of an apartment, an office or a store, or even, in certain cases, outdoor walls, without excessive expenditure and without requiring special works.

It consists of a wall support having a vertical frontal surface comprising one or more receptacles each provided with an opening located in the same plane as the said frontal surface, the receptacles being equipped at the periphery of their opening with an inner rim suitable, when the support is fastened to a wall, for holding one or more plants which can be planted in a lump of soil or another substrate.

### BRIEF DESCRIPTION OF THE FIGURES

In the appended drawings, provided as non-limiting exemplary embodiments of the object of the present application:

FIG. 1 shows a device according to the invention in an isometric projection, in a frontal view,

FIG. 2 shows, in the same conditions, the device seen from the side,

FIG. 3 shows, also in the same conditions, the device placed flat and without plants,

FIG. 4 shows, in a front view, an alternative of the device provided with a built-in sprinkling system,

FIG. 5 shows, unfolded, a box made from cardboard or plastic sheet,

and FIGS. 6 and 7 show exemplary embodiments of the device of the invention.

### DETAILED DESCRIPTION

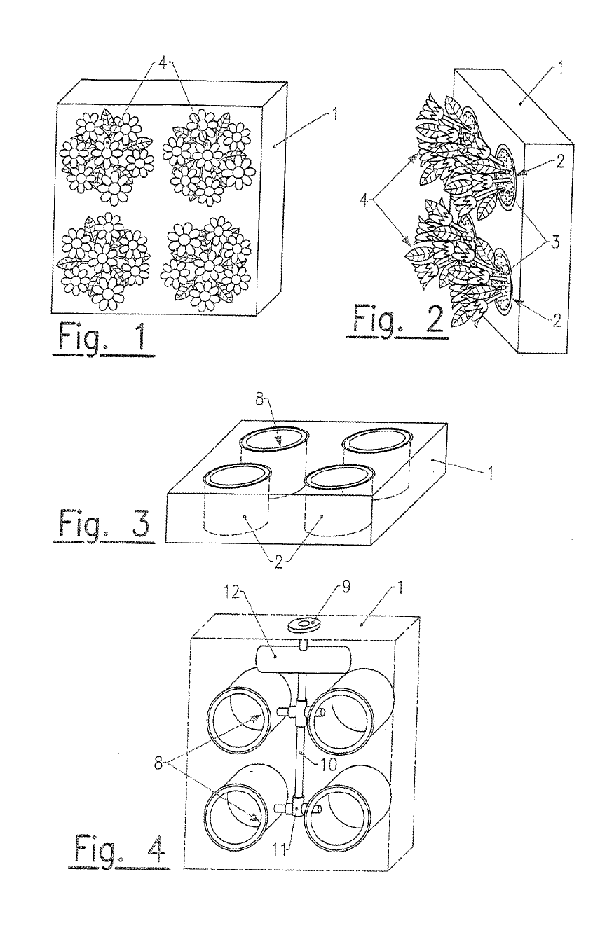

The device, in FIGS. 1 to 3, consist of a support 1 or box which can be fastened to the wall and comprises one or more receptacles 2 containing the substrate 3 intended to accommodate the plants 4, preferably consisting of “mini-plants” or “micro-plants” but possibly also being cut flowers immersed in a liquid nutrient substrate or one having a gel consistency.

In this case, the receptacles may consist of tubes closed by a flexible seal perforated to pass the flower stem or stems through, these tubes being horizontal or not, straight or curved.

The support 1 may be provided in various forms, square, rectangular, triangular, circular or other, and may comprise any number of receptacles 2. It may in particular comprise a single receptacle 2 and may be provided with a system of fasteners on the side for modular assembly of a plurality of devices as required (FIG. 6).

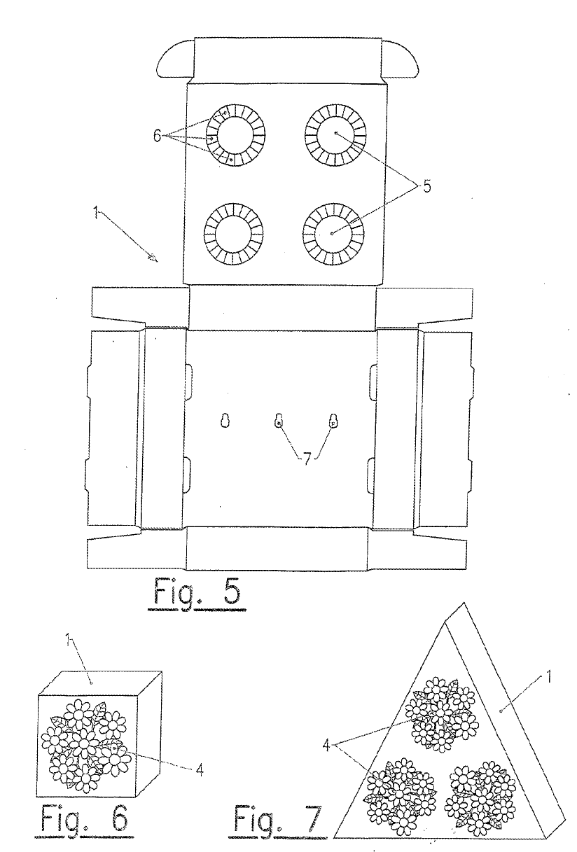

Various materials can be used to produce the support 1, for example plastic, metal, wood or ceramic. However, in order to obtain a very low price, it is preferably made from folded cardboard. In this case, it comprises on its front cutouts 5 accommodating the receptacles 2 and whereof the periphery comprises a series of foldable tabs 6 arranged to firmly secure the said receptacles. One or more perforations 7 are provided on the back for fastening (FIG. 5).

The receptacles 2 may be removable or not. They can be prepared from a watertight material in order to be able to sprinkle the soil 3 in which the plants 4 are planted. They can in particular be produced from the same material as the support 1, the whole thereby constituting a single piece obtained for example by moulding, or made from ceramic. According to a particular embodiment, the support 1 is made from ceramic, itself forming a single receptacle with a single opening. The substrate can advantageously consist of peat moss compacted in the receptacle formed by the support 1.

The lumps of soil 3 are forced into the receptacles 2 and held in place by an inner rim 8 of their opening. Each lump of soil can advantageously be contained in a net similar to hairnets. For transport, a removable split flange being inserted behind the rim 8 of each receptacle 2 can be provided to secure each lump of soil 3.

The sprinkling of the soil 3, once the device is fastened to the wall, can be carried out using a pipette or any other appropriate means. The receptacles can advantageously contain a “water gel” for very infrequent sprinklings.

According to an alternative shown in FIG. 4, the device can be equipped with a sprinkling system consisting of a water inlet 9 and an internal network of tubes 10 and fittings 11 feeding each receptacle 2. A water reserve 12 is advantageously provided.

The device can be sold with or without plants 4, which can be planted by the user.

The positioning of the various components gives the subject matter of the invention a maximum of useful effects, which have heretofore not been obtained by similar devices.

1. Wall support device for all types of plants, suitable for ornamenting the walls and in particular the indoor walls of residential as well as professional premises,
the device comprising a wall support or box having a vertical frontal surface comprising one or more receptacles, removable or not, provided with an opening located in the same plane as the said frontal surface, each receptacle being arranged to hold a lump of soil or a substrate receiving the plant or plants when the box is fastened to a wall.

2. Device according to claim 1, wherein each receptacle is equipped at the periphery of its opening with an inner rim suitable for holding a lump of soil receiving the plant or plants when the box is fastened to a wall.

3. Device according to claim 2, wherein the device is supplied with a removable split flange inserted behind the rim of each receptacle for securing the lump of soil.

4. Device according to claim 1, wherein the plant or plants are planted in a lump of soil contained in a net similar to hairnets.

5. Device according to claim 1, wherein the plant or plants are stem flowers immersed in a liquid nutrient substrate or one having a gel consistency, the receptacles consisting of tubes closed by a flexible seal perforated to pass the flower stem or stems through, these tubes being horizontal or not, straight or curved.

6. Device according to any one of the preceding claims, wherein the support is made from folded cardboard and comprises cutouts on its front accommodating the receptacles and whereof the periphery comprises a series of foldable tabs arranged to firmly secure the said receptacles, one or more perforations being provided on the back of the support for its fastening.

7. Device according to any one of claim 1, wherein the receptacle or receptacles is (are) produced from the same material as the support, the whole possibly consisting of a single piece obtained for example by moulding.

8. Device according to claim 7, wherein the support is made from ceramic, itself forming a single receptacle with a single opening, the substrate consisting of peat moss compacted in the receptacle formed by the support.

9. Device according to claim 1, wherein the support is equipped with a sprinkling system consisting of a water inlet and an internal network of tubes and fittings feeding each receptacle.

10. Device according to claim 9, wherein the sprinkling system comprises a water reserve.

11. Device according to claim 1, wherein the device is sold without plants which are planted by the user.
